(19) United States
(12) Patent Application Publication
(10) Pub. No.: US 2023/0045706 A1
(43) Pub. Date: Feb. 9, 2023

(54) SYSTEM FOR DISPLAYING ATTENTION TO NEARBY VEHICLES AND METHOD FOR PROVIDING AN ALARM USING THE SAME

(71) Applicants: Hyundai Motor Company, Seoul (KR); Kia Corporation, Seoul (KR)

(72) Inventor: Won Young Jeong, Hwaseong (KR)

(21) Appl. No.: 17/880,248

(22) Filed: Aug. 3, 2022

(30) Foreign Application Priority Data
Aug. 6, 2021 (KR) 10-2021-0103576

(51) Int. Cl. G08G 1/16; B60K 35/00; G08G 1/052; G08G 1/01

(52) U.S. Cl. CPC G08G 1/163; B60K 35/00; G08G 1/052; G08G 1/0125; G08G 1/0137; G08G 1/0112; B60K 2370/152

(57) ABSTRACT

At least one nearby vehicle may be extracted from a vehicle vicinity image collected by a sensor equipped in the target vehicle. Lane recognition information representing which one position a position of the extracted nearby vehicle corresponds to with respect to the target vehicle, and/or vehicle position information representing a relative distance from the target vehicle to the nearby vehicle may be identified. An attention degree of the nearby vehicle may be calculated based on a speed of the nearby vehicle calculated from the relative distance and a vehicle speed of the target vehicle, the vehicle position information of the nearby vehicle, the relative distance of the nearby vehicle, the speed of the target vehicle, or any combination thereof. An alarm for the nearby vehicle may be displayed on a screen according to the calculated attention.

### CROSS-REFERENCE TO RELATED APPLICATION

This application claims under 35 U.S.C. § 119(a) priority to Korean Patent Application No. 10-2021-0103576 filed in the Korean Intellectual Property Office on Aug. 6, 2021, the entire contents of which are incorporated herein by reference.

### BACKGROUND

### (a) Field

The present disclosure relates to a system for displaying an attention degree of a nearby vehicle using a vehicle camera and a method for providing an alarm using the system.

### (b) Description of the Related Art

In general, when driving a vehicle, a driver observes nearby vehicles for safe driving. And based on driving experience of the driver, the driver subjectively determines whether a nearby vehicle may be a vehicle that is a risk for driving or a vehicle that is driven safely.

If the driver determines that the nearby vehicle may be dangerously driven due to frequent lane changes, drowsy driving, and the like, the driver should pay more attention to driving.

At this time, the number of nearby vehicles that may be determined through the driver's eyes may be very restricted. Further, for a vehicle moving behind the driver, there may be a problem that the driver cannot continuously observe the vehicle. Also, since the power of observation on the nearby vehicles may be different depending on driving skill of the driver, there may be a an erroneous determination of how much attention should be paid to a driver based on the driving experience of the driver.

The above information disclosed in this Background section is only for enhancement of understanding of the background of the disclosure, and therefore it may contain information that does not form the prior art that is already known to a person of ordinary skill in the art.

### SUMMARY

The present disclosure provides a system for displaying attention degree of a nearby vehicle using a vehicle camera, which may quantify a driving attention degree of the nearby vehicle and may continuously provide the driver with the driving attention degree of the nearby vehicle, and a method for providing an alarm using the system.

The present disclosure provides a method for displaying a vehicle attention degree of a nearby vehicle by a system for displaying vehicle attention degree of a nearby vehicle, operated by at least one processor.

The method includes extracting at least one nearby vehicle from a vehicle image collected by a sensor equipped in the target vehicle, identifying lane recognition information representing which one position a position of the nearby vehicle corresponds to with respect to the target vehicle, and a relative vehicle position information representing a relative distance from the target vehicle to the nearby vehicle, calculating an attention degree of the nearby vehicle, based on a speed of the nearby vehicle calculated from the relative distance and a vehicle speed of the target vehicle, the vehicle position information of the nearby vehicle, the relative distance of the nearby vehicle, and the speed of the target vehicle, and displaying by a display device an alarm for the nearby vehicle according to the calculated attention degree on a screen.

Identifying the vehicle position information may include determining whether the nearby vehicle may be in a left lane or in a right lane with respect to the target vehicle, or the nearby vehicle may be driving in the same lane as the target vehicle, and setting the lane recognition information of the target vehicle according to a position of the target vehicle.

Identifying the vehicle position information may include identifying a distance from the target vehicle to the nearby vehicle, and calculating the relative distance by adjusting the distance with a predetermined rate.

Identifying the vehicle position information may include setting the relative distance as a positive integer when the nearby vehicle may be driving in front of the target vehicle, and setting the relative distance as a negative integer when the nearby vehicle may be driving behind the target vehicle.

Extracting the nearby vehicle may include recognizing a vehicle type of the nearby vehicle.

Identifying the vehicle position information may further include indexing the vehicle type, the lane recognition information, and the vehicle position information as vehicle information of the nearby vehicle.

Calculating the attention degree of the nearby vehicle may include calculating a vehicle speed of the nearby vehicle based on the vehicle speed of the target vehicle, a current relative distance of the nearby vehicle, and a previous relative distance of the nearby vehicle.

Calculating the attention degree of the nearby vehicle may include setting a window for the nearby vehicle and checking a center of the window, and identifying an inter-lane position of the nearby vehicle based on the center of the window.

Calculating the attention degree of the nearby vehicle may include detecting a number of lane changes of the nearby vehicle, whether a brake light of the nearby vehicle may be turned on, and a frequency of lighting the brake light of the nearby vehicle from the vehicle vicinity image.

Calculating the attention degree of the nearby vehicle may include calculating the attention degree of the nearby vehicle based on the speed of the nearby vehicle, the vehicle position information of the nearby vehicle, the relative distance of the nearby vehicle, and the vehicle speed of the target vehicle, when the nearby vehicle may be either in front of or behind the target vehicle.

Calculating the attention degree of the nearby vehicle may include calculating the attention degree of the nearby vehicle by additionally using the number of lane changes, a speed limit of a road where the vehicles may be driving, the vehicle speed of the target vehicle, and the inter-lane position of the nearby vehicle.

Calculating the attention degree of the nearby vehicle may include calculating the attention degree of the nearby vehicle based on a number of nearby vehicles positioned in a blind spot of the target vehicle, when the nearby vehicle may be positioned in the blind spot of the target vehicle.

Displaying the alarm on the screen may include outputting an alarm image and sound simultaneously when the calculated attention degree is greater than or equal to a predetermined first threshold, and outputting the alarm image when the calculated attention degree is greater than a predetermined second threshold or is less than the first threshold.

The present disclosure further provides a system for displaying an attention degree of a nearby vehicle.

The system includes a sensor that collects a vehicle vicinity image of the target vehicle, a display that displays an image of the nearby vehicle and an alarm for the nearby vehicle, and a processor. The processor is configured to identify vehicle recognition information and a relative distance of the nearby vehicle from the vehicle vicinity image, and calculate the attention degree of the nearby vehicle based on a vehicle speed of the nearby vehicle calculated from the relative distance and the vehicle speed of the target vehicle, the vehicle speed of the target vehicle, the relative distance, and vehicle position information of the nearby vehicle.

The processor may be trained with training data in which a vehicle and a vehicle type may be mapped for recognition of the vehicle type of the nearby vehicle.

The processor may be configured to set a window for the nearby vehicle, identify a center of the window, and identify an inter-lane position of the nearby vehicle based on the center of the window.

The processor may be configured to extract a number of lane changes of the nearby vehicle, whether a brake light of the nearby vehicle may be turned on, and a frequency of lighting the brake light of the nearby vehicle, which may be used as parameters for calculating the attention degree of the nearby vehicle.

According to the present disclosure, since an attention degree of a nearby vehicle may be monitored via a vehicle camera, continuous monitoring may be performed.

A driver may be guided by a notification so that the driver may defensively drive for a nearby vehicle with a high risk of accident, thereby preventing a danger of an additional accident.

In addition, since an attention degree of a nearby vehicle may be visually displayed on an in-vehicle display device, a driver may easily recognize the attention degree of a nearby vehicle.

In a further embodiment, a vehicle is provided that comprises one or more system for displaying an attention degree of a nearby vehicle as disclosed herein.

### BRIEF DESCRIPTION OF THE DRAWINGS

FIG. 1 is an example diagram of an environment to which a display system of attention degree of nearby vehicles according to an embodiment of the present disclosure is applied.

FIG. 2 is a configuration diagram of a display system of attention degree of nearby vehicles according to an embodiment of the present disclosure.

FIG. 3 is a flowchart showing a method for displaying attention degree of nearby vehicles according to an embodiment of the present disclosure.

FIG. 4 is a flowchart showing a method for quantifying a vehicle attention degree according to an embodiment of the present disclosure.

FIG. 5 is an example diagram showing how to identify an inter-lane vehicle position of a nearby vehicle according to an embodiment of the present disclosure.

FIG. 6 and FIG. 7 are example diagrams of a screen on which a vehicle attention degree may be displayed according to an embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion, of any other elements. In addition, the terms “unit”, “-er” “-or” and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In the following detailed description, only certain embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Hereinafter, a system for displaying an attention degree of a nearby vehicle and a method for providing an alarm using the system, according to an embodiment of the present disclosure, will be described with reference to the accompanying drawings.

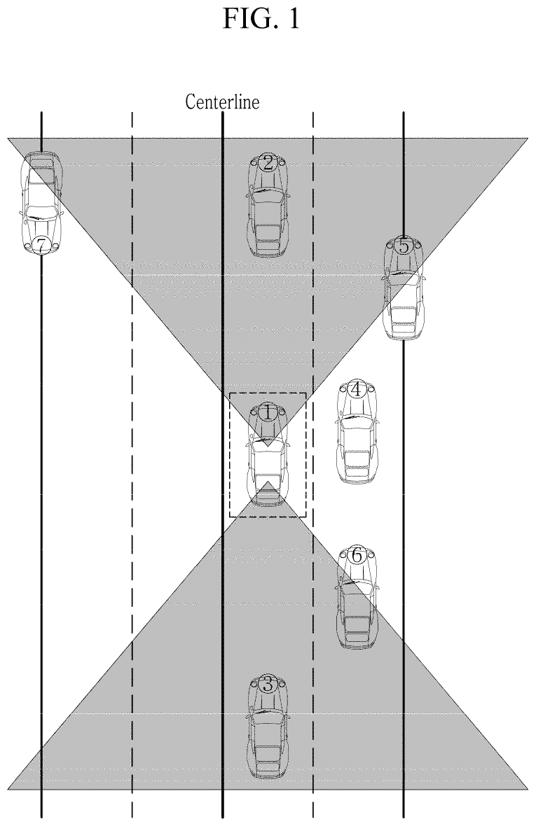

FIG. 1 is an example diagram of an environment to which a display system of attention degree of nearby vehicles according to an embodiment of the present disclosure may be applied.

As shown in FIG. 1, each vehicle (\textcircled{1}-\textcircled{7}) may be equipped with a display system of attention degree of nearby vehicles. Then, information of nearby vehicles may be collected using a front camera and a rear camera equipped in each vehicle (\textcircled{1}-\textcircled{7}).

An embodiment of the present disclosure is described with an example in which information may be collected on a front vehicle (\textcircled{2}), a rear vehicle (\textcircled{3}), a vehicle positioned in a blind spot (\textcircled{4}), and vehicles positioned on the side (\textcircled{5}, \textcircled{6}) with respect to a target vehicle(W). Here, for the convenience of description, the vehicle positioned in the blind spot(\textcircled{4}) and the vehicles positioned on the side (\textcircled{5}, \textcircled{6}) may be referred to as ‘blind spot vehicles’.

An embodiment of the present disclosure may be described with an example in which information on an oncoming vehicle (\textcircled{7}) proceeding in the opposite direction with respect to a centerline may not be collected. However, a display service of attention degree of nearby vehicles provided by an embodiment of the present disclosure may be provided through collecting information on the oncoming vehicle (\textcircled{7}).

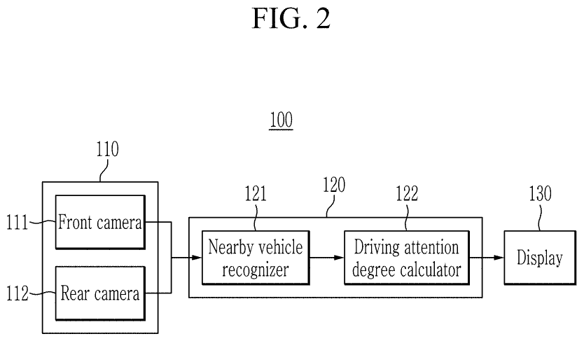

A structure of a display system of attention degree of nearby vehicles that may be to provide a driver with the attention degree may be described with reference to FIG. 2.

FIG. 2 is a configuration diagram of a display system of attention degree of nearby vehicles according to an embodiment of the present disclosure.

As shown in FIG. 2, a display system 100 of attention degree of nearby vehicles includes a sensor 110 that collects an image, a processor 120 that calculates an attention degree of a nearby vehicle by processing the image, and a display 130 that displays the attention degree of the nearby vehicle on a screen for recognition of a driver.

In an embodiment of the present disclosure, the sensor 110 including a front camera 111 installed in a first position of a vehicle and a rear camera 112 installed in a second position of the vehicle may be described as an example. However, information collecting means (e.g., image sensor, speed sensor, radar sensor, lidar sensor, and the like) that may collect information about the nearby vehicles of the vehicle may be used.

After the front camera 111 and the rear camera 112 collect images around the vehicle (hereinafter, referred to as ‘vehicle vicinity images’), the processor 120 is configured to process the collected image and then calculate a driving attention degree. For this, the processor 120 includes a nearby vehicle recognizer 121 and a driving attention degree calculator 122. The processor may be understood as a controller as described herein. For example, the processor may be in communication with memory that has stored thereon non-transitory machine readable instructions that when executed by the processor perform the methods and functions described herein. In addition, the nearby vehicle recognizer and/or driving attention degree calculator may be a combination of hardware and/or software that operates in combination with the processor to achieve the described functions of these modules. The memory is configured to store the modules and the processor is specifically configured to execute said modules to perform one or more processes which are described further below

The nearby vehicle recognizer 121 checks whether there may be nearby vehicles in the vehicle vicinity images collected by the front camera 111 and the rear camera 112. The method with which the nearby vehicle recognizer 121 extracts the nearby vehicles from the vehicle vicinity images may be implemented using various methods for extracting a certain object from an image.

The nearby vehicle recognizer 121 also recognizes types of the extracted nearby vehicles. In an embodiment of the present disclosure, vehicle types may be classified into a small car, a passenger car, a large car, and others. The small car may include a motorcycle. The passenger car may include a common passenger car, and the large car may include vehicles such as a bus and a truck. In addition, the others may include means for running on the road, such as a bicycle and an electric kickboard.

In order to extract the nearby vehicle from the vehicle vicinity image and to recognize the vehicle type of the extracted vehicle, the nearby vehicle recognizer 121 may have been trained with training data in advance such as through machine learning on a training data set.

Namely, using a training data set that includes images for each type of vehicle and vehicle information mapped to each of the images, the nearby vehicle recognizer 121 may be trained so that vehicle information mapped to the image may be output upon receiving images. Since there may be various methods for training the nearby vehicle recognizer 121 with the training data, the method may not be limited to any one method in an embodiment of the present disclosure.

In addition, the nearby vehicle recognizer 121 may be configured to index vehicle information to the nearby vehicles based on a distance to each nearby vehicle recognized from a target vehicle and a lane where the nearby vehicle may be positioned. The vehicle information may include lane recognition information and nearby vehicle position information.

For this, the nearby vehicle recognizer 121 may be configured to set a window for each nearby vehicle in a vehicle vicinity image. Then, the nearby vehicle recognizer 121 may be configured to identify an image center of the set window, and determine an exact lane position of the nearby vehicle using the image center.

That is, when the nearby vehicle may be in a left lane of a target vehicle, the nearby vehicle recognizer 121 assigns any one value of 1, 2, 3, and 4 to the lane recognition information. For example, when a nearby vehicle may be in a left lane close to a driving lane of the target vehicle, the nearby vehicle recognizer 121 may assign a large value to the lane recognition information. However, the present disclosure may not be necessarily limited thereto.

Further, when the nearby vehicle may be in a right lane of the target vehicle, the nearby vehicle recognizer 121 may assign any one value of 6, 7, 8 and 9 to the lane recognition information. For example, when the nearby vehicle may be in the right lane close to the driving lane of the target vehicle, the nearby vehicle recognizer 121 may assign a large value to the lane recognition information.

The nearby vehicle recognizer 121 may assign a value of 5 to the lane recognition information when the nearby vehicle may be in the same lane as the target vehicle.

In addition, the nearby vehicle recognizer 121 may be configured to identify a distance to the nearby vehicle from the target vehicle. Then, the nearby vehicle recognizer 121 may assign a relative distance obtained through converting 10 m to 1 m, to the nearby vehicle position information. An embodiment of the present disclosure may be described with an example in which the nearby vehicle recognizer 121 converts 10 m to 1 m, but may not be limited thereto.

At this time, the nearby vehicle recognizer 121 may assign an integer value to the nearby vehicle position information when the nearby vehicle may be driving ahead of the target vehicle. However, the nearby vehicle recognizer 121 may assign a negative (−) value to the nearby vehicle position information when the nearby vehicle may be being driven behind the target vehicle. Further, the nearby vehicle recognizer 121 may indicate the nearby vehicle position information as 0 when the nearby vehicle may be in the blind spot of the target vehicle.

For example, it may be assumed that the target vehicle may be driving in a second lane and a bus among the nearby vehicles may be driving 50 m ahead of the target vehicle in a first lane, on a three-lane one-way road. At this time, the nearby vehicle recognizer 121 may index vehicle information on the bus as ‘b4/5’.

As another example, it may be assumed that the target vehicle may be driving in a second lane and a passenger vehicle among the nearby vehicles may be driving 100 m behind the target vehicle in the second lane, on a three-lane road. Then, the nearby vehicle recognizer 121 may index the vehicle information on the passenger vehicle as ‘p5/-10’.

The driving attention degree calculator 122 may be configured to calculate a driving attention degree of each of multiple nearby vehicles based on the target vehicle. For this, the driving attention degree calculator 122 may be configured to calculate a vehicle speed of each nearby vehicle based on a vehicle speed of the target vehicle and the relative distance of each nearby vehicle.

That is, the driving attention degree calculator 122 may calculate the vehicle speed of the nearby vehicle using an equation “Speed of nearby vehicle=speed of target=vehicle+(current relative distance−relative distance before 1 second)*3.6”.

For example, it may be assumed that the vehicle speed of the target vehicle may be 20 km/h, the current relative distance to a certain nearby vehicle may be 12 m, and the relative distance to the certain nearby vehicle before 1 second may be 10 m. Then, the driving attention degree calculator 122 obtains the nearby vehicle speed of 27.2 km/h from calculating 20 km/h+(12 m−10 m)*3.6.

The driving attention degree calculator 122 may be configured to determine an inter-lane position representing in which lane the nearby vehicle may be positioned between lanes. In an embodiment of the present disclosure, values of 5, 1, and 9 may be assigned to a center, a left end, and a right end of a lane, respectively. And, the inter-lane position representing in which position a nearby vehicle may be positioned between lanes may be given a value.

For this, the driving attention degree calculator 122 may be configured to check the image center based on a window set for the nearby vehicle. Then, the driving attention degree calculator 122 may place the window of the nearby vehicle between two lanes, and assigns a score of the point where the image center may be placed as a value of the inter-lane position of the nearby vehicle.

Further, the driving attention degree calculator 122 may count the number of lane changes of the nearby vehicle. In addition, the driving attention degree calculator 122 may check whether a brake light may be turned on. The determine the number of lane changes and/or a quantity of braking in one or more durations of time.

The driving attention degree calculator 122 may be configured to quantify a driving attention degree based on any combination of the determined speed of the nearby vehicle, a position of lane change, whether the brake light may be turned on, frequency of lighting the brake light, the relative distance, and the like. Hereinafter, a method with which the driving attention degree calculator 122 quantifies the driving attention degree of nearby vehicles may be described in detail.

When the quantified driving attention degree may be greater than or equal to a predetermined first threshold, the driving attention degree calculator 122 may be configured to generate a control signal so that an alarm image and/or sound may be output via the display 130. In an exemplary embodiment the alarm image and sound may be simultaneously output via the display 130.

When the driving attention degree may be greater than or equal to a second threshold and may be less than the first threshold, the driving attention degree calculator 122 may generate a control signal so that only the alarm image may be output via the display 130.

In addition, the driving attention degree 122 may be configured to determine not to output the alarm image via the display 130 when the driving attention degree may be less than the second threshold.

Based on the control signal generated by the processor 120, the display 130 provides along with an image showing nearby vehicles. At this time, for a nearby vehicle of a high driving attention degree, the display 130 may further provide to a driver through other expressing means such as sound.

In an embodiment of the present disclosure, when the driving attention degree may be greater than or equal to a predetermined first threshold, the display 130 provides an alarm image with a different color through a display device such as an audio video navigation (AVN), a cluster, and a multimedia or heads up display hub. In an example, the display 130 may simultaneously output sound to provide the driver.

If the driving attention degree is greater than or equal to a predetermined second threshold and is less than the first threshold, the display 130 may provide only an alarm image with a different color on the display device. Further, the display 130 may not display any separate alarm image when the driving attention degree may be less than the second threshold.

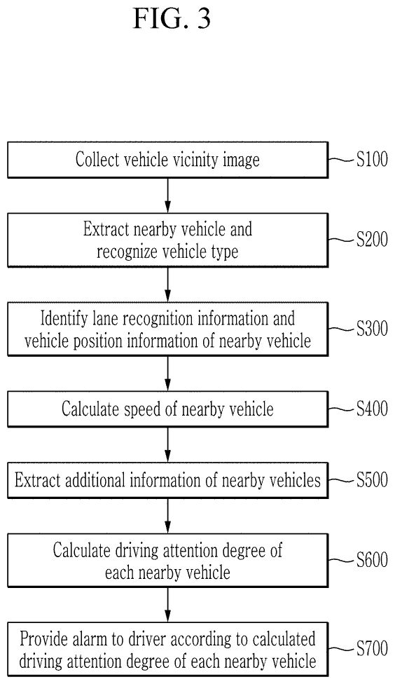

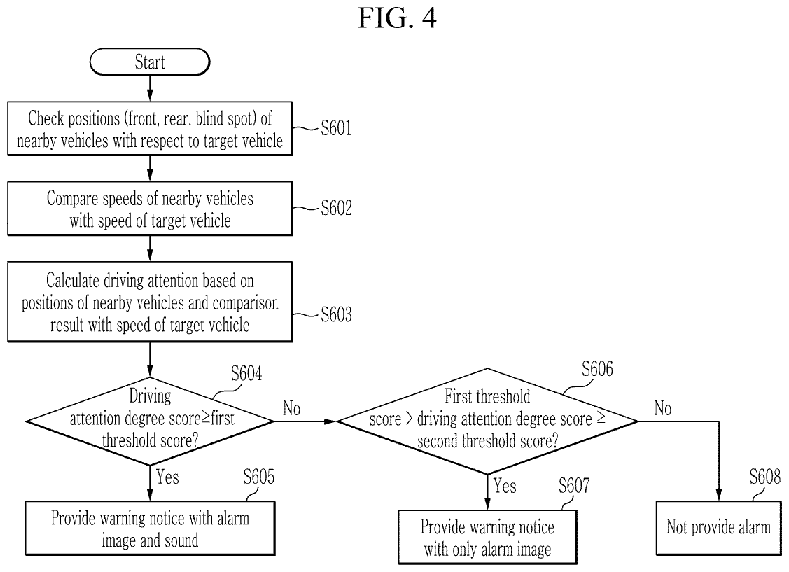

A method with which the above-described display system 100 of attention degree of nearby vehicles calculates an attention degree of a nearby vehicle and displays the calculated attention degree may be described with reference to FIG. 3 and FIG. 4.

FIG. 3 is a flowchart showing a method for displaying attention degree of nearby vehicles according to an embodiment of the present disclosure.

As shown in FIG. 3, a display system 100 of attention degree of nearby vehicles equipped in a target vehicle collects images of nearby vehicles using various sensors (S100). An embodiment of the present disclosure may be described with an example of collecting vehicle vicinity images using a front camera 111 and a rear camera 112.

The display system 100 of attention degree of nearby vehicles may be configured to extract at least one nearby vehicle from the collected vehicle vicinity image. Simultaneously, the system 100 for displaying attention degree of nearby vehicles may be configured to identify a vehicle type of the extracted nearby vehicle (S200). For this, the display system 100 of attention degree of nearby vehicles has been trained to extract the vehicle type upon receiving vehicle images, using training data in advance.

After setting a window for the nearby vehicle in the vehicle vicinity image, the display system 100 of attention degree of nearby vehicles may identify lane recognition information and/or vehicle position information of the nearby vehicle (S300). The vehicle recognition information may be information of a lane where the nearby vehicle may be driving and/or the vehicle position information means a relative distance of the nearby vehicle from a target vehicle.

For example, it may be assumed that the target vehicle may be driving in a second lane, and a bus among the nearby vehicles may be driving 50 m ahead of the target vehicle in a first lane, on a three-lane one-way road. At this time, the nearby vehicle recognizer 121 indexes vehicle information on the bus as ‘b4/5’.

The display system 100 of attention degree of nearby vehicles calculates a speed of the nearby vehicle, based on the lane recognition information and vehicle position information of the nearby vehicle identified in step S300, a vehicle speed of the target vehicle, or any combination thereof (S400).

For example, it may be assumed that the vehicle speed of the target vehicle may be 20 km/h, a current relative distance to a certain nearby vehicle may be 12 m, and a relative distance to the certain nearby vehicle before 1 second may be 10 m. Then, the system 100 for displaying attention degree of nearby vehicles calculates the vehicle speed of the corresponding nearby vehicle as 27.2 km/h from calculating 20 km/h+(12 m−10 m)*3.6.

The display system 100 of attention degree of nearby vehicles also extracts additional information of the corresponding nearby vehicle from the vehicle vicinity image (S500). Here, the additional information includes information on how many times the corresponding nearby vehicle changed lanes, whether a brake light may be turned on, a frequency of lighting the brake light, or a combination thereof.

The display system 100 of attention degree of nearby vehicles calculates a driving attention degree of each nearby vehicle by using the information of the nearby vehicles identified or calculated in step S300 to step S500 (S600). Then, according to the calculated score of the driving attention degree, various types of alarms may be provided to a driver (S700).

Here, a method with which a display system 100 of attention degree of nearby vehicles calculates a driving attention degree of a nearby vehicle in step S600 may be described with reference to FIG. 4.

FIG. 4 is a flowchart showing a method for quantifying a vehicle attention degree according to an embodiment of the present disclosure.

As shown in FIG. 4, a display system 100 of attention degree of nearby vehicles checks whether a nearby vehicle may be in front of, behind, or in a blind spot of a target vehicle, based on vehicle information indexed to a nearby vehicle (S601).

At this time, if the nearby vehicle is in front of the target vehicle, a positive integer value is assigned to nearby vehicle position information. Further, if the nearby vehicle is behind the target vehicle, a negative integer value is assigned to the nearby vehicle position information. And, when the nearby vehicle is in the blind spot, 0 is assigned to the nearby vehicle position information. Based on the nearby vehicle position information, the display system 100 of attention degree of nearby vehicles can determine positions of the nearby vehicles.

The display system 100 of attention degree of nearby vehicles compares speeds of the nearby vehicles with a speed of the target vehicle (S602). And, the display system 100 of attention degree of nearby vehicles calculates the driving attention of nearby vehicles, based on a comparison result of speeds, and the position information and the additional information of the nearby vehicles (S603).

That is, the display system 100 of attention degree of nearby vehicles quantifies the driving attention degree using Equation 1 to Equation 3 for each of the cases where a nearby vehicle may be in the front, in the rear, and in a blind spot, respectively.

Driving attention to front nearby vehicle=(number of lane changes*a)+(|speed limit−speed of target vehicle|*b)+((inter-lane position−c)*d)+((speed of front vehicle−speed of vehicle in front of front vehicle))*e)+(acceleration of target vehicle*+(frequency of lighting brake light*g)+(h/relative distance) Equation 1

Driving attention to rear nearby vehicle=(number of lane changes*a)+(|speed limit−speed of target vehicle|*b)+((inter-lane position−c)*d)+(acceleration of target vehicle*e)+(f/relative distance) Equation 2

Driving attention to nearby vehicle in blind spot=(number of nearby vehicles−3)*a Equation 3

Here, a, b, c, d, e, f, g and h mentioned in the above-described Equation 1 to Equation 3 may be weights. The weights may not be limited to any one numerical value and may be set through a predetermined algorithm (e.g. program and probability model). The display system 100 of attention degree of nearby vehicles will be described with an example that a large attention degree may be set for a vehicle with a high driving speed.

For example, when a nearby vehicle may be in the front, different weights may be assigned for a nearby vehicle with a higher speed than the target vehicle and a nearby vehicle with a lower speed than the target vehicle.

That is, when the speed of the nearby vehicle may be lower than that of the target vehicle, the display system 100 of attention degree of nearby vehicles may be assumed to have calculated the driving attention degree with equation ‘(number of lane changes*10)+(|speed limit−speed of target vehicle|*1.3)+((inter-lane position−5)*10)+((speed of front vehicle−speed of vehicle in front of front vehicle)*1.5)+(acceleration of target vehicle*9)+(frequency of lighting brake light*10)+(300/relative distance)’.

Then, when the speed of the nearby vehicle may be higher than that of the target vehicle, the display system 100 of attention degree of nearby vehicles calculates the driving attention degree with equation ‘(number of lane changes*10)+(|speed limit−speed of target vehicle|*1.5)+((inter-lane position−5))*15)+((speed of front vehicle−speed of vehicle in front of front vehicle)*2.0)+(acceleration of target vehicle*12)+(frequency of lighting brake light*15)+(100/relative distance)’.

The display system 100 of attention degree of nearby vehicles checks whether the driving attention degree of the nearby vehicle calculated in step S603 may be greater than or equal to a predetermined first threshold score (S604). If the driving attention degree may be greater than or equal to the first threshold score, the display system 100 of attention degree of nearby vehicles provides an alarm to a driver of the target vehicle with an alarm image and sound (S605).

However, when the calculated driving attention degree of the nearby vehicle may be greater than or equal to a second threshold score but may be less than the first threshold score, the display system 100 of attention degree of nearby vehicles provides only the alarm image to the driver of the target vehicle as the alarm (S607).

When the calculated driving attention degree of the nearby vehicle may be less than the second threshold score, the display system 100 of attention degree of nearby vehicles does not provide any alarm such as alarm image and sound (S608).

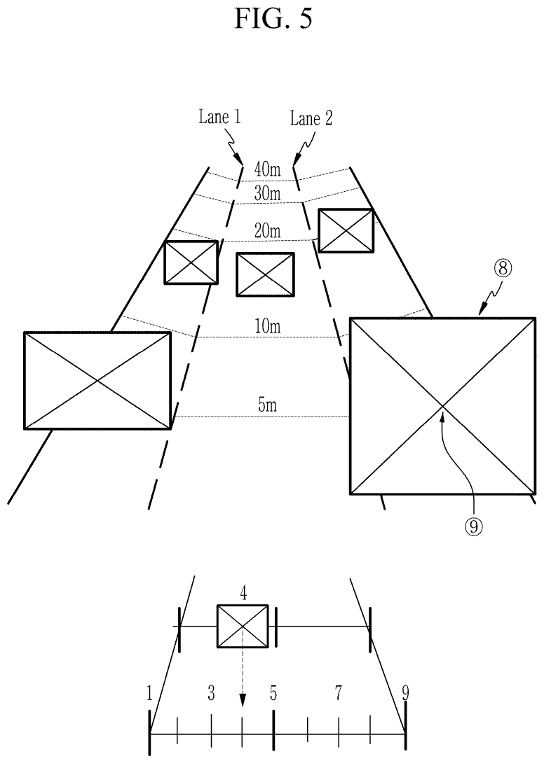

Hereinafter, an example of identifying a position of a nearby vehicle between lanes may be described with reference to FIG. 5.

FIG. 5 is an example diagram showing how to identify an inter-lane vehicle position of a nearby vehicle according to an embodiment of the present disclosure.

As shown in FIG. 5, a display system 100 of attention degree of nearby vehicles sets a window (\textcircled{8}) for each nearby vehicle in a vehicle vicinity image. And, the display system 100 of attention degree of nearby vehicles determines an image center e(\textcircled{9}) of the window.

The display system 100 of attention degree of nearby vehicles places the window (\textcircled{8}) of the nearby vehicle on a position between two lanes, and sets a score of the point where the image center (\textcircled{9}) may be placed as an inter-lane position value of the nearby vehicle.

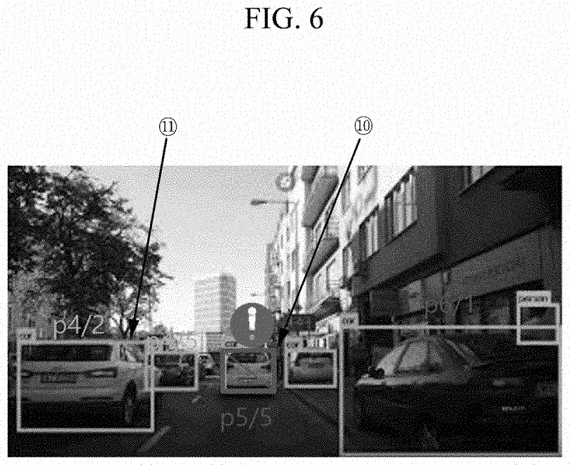

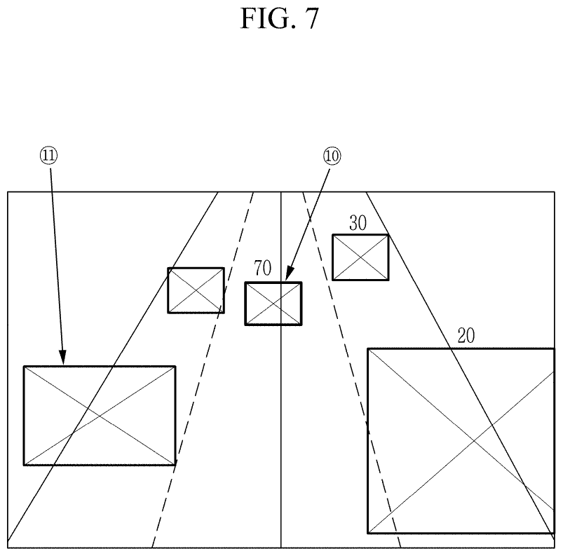

Hereinafter, an example in which a display system 100 of attention degree of nearby vehicles displays a vehicle attention degree on a screen may be described with reference to FIG. 6 and FIG. 7.

FIG. 6 and FIG. 7 are example diagrams of a screen on which a vehicle attention degree may be displayed according to an embodiment of the present disclosure.

The display system 100 of attention degree of nearby vehicles displays vehicle information about each nearby vehicle on windows set for nearby vehicles. As shown in FIG. 5 and FIG. 6, when a display device for showing images of a nearby vehicle may be equipped, the vehicle information may be separately displayed on an image of each nearby vehicle.

At this time, if a driving attention score is greater than or equal to a first threshold score, a notification is provided to a driver using a separate color or a separate image like a first display means ( [symbol] ). However, if the driving attention score is less than the first threshold score but is greater than or equal to a second threshold score, a notification is provided to the driver using a separate color or a separate image like a second display means ( [symbol] ) being distinguished from the first display means.

On the other hand, if there may be no image display device, the display system 100 of attention degree of nearby vehicles may guide a direction and position, such as front, rear, right, and left, using audio via a sound device.

While this disclosure has been described in connection with what may be presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A method for displaying a vehicle attention degree of a nearby vehicle by a system for displaying a vehicle attention degree of at least one nearby vehicle, operated by at least one processor, the method comprising:
extracting by the at least one processor at least one nearby vehicle from a vehicle image collected by a sensor equipped in the target vehicle;
identifying by the at least one processor lane recognition information representing which one position a position of the at least one nearby vehicle corresponds to with respect to the target vehicle, and vehicle position information representing a relative distance from the target vehicle to the at least one nearby vehicle;
calculating by the at least one processor an attention degree of the at least one nearby vehicle, based on a speed of the at least one nearby vehicle calculated from the relative distance and a vehicle speed of the target vehicle, the vehicle position information of the at least one nearby vehicle, the relative distance of the at least one nearby vehicle, and the vehicle speed of the target vehicle; and
displaying by a display device an alarm for the at least one nearby vehicle according to the calculated attention degree on a screen.

2. The method of claim 1, wherein identifying the vehicle position information comprises
determining by the at least one processor whether the at least one nearby vehicle is in a left lane or in a right lane with respect to the target vehicle, or the at least one nearby vehicle is driving in the same lane as the target vehicle, and
setting the lane recognition information of the target vehicle according to a position of the target vehicle.

3. The method of claim 2, wherein identifying the vehicle position information comprises
identifying a distance from the target vehicle to the at least one nearby vehicle, and
calculating the relative distance by adjusting the distance with a predetermined rate.

4. The method of claim 3, wherein identifying the vehicle position information comprises
setting the relative distance as a positive integer when the at least one nearby vehicle is driving in front of the target vehicle, and
setting the relative distance as a negative integer when the at least one nearby vehicle is driving behind the target vehicle.

5. The method of claim 4, wherein extracting the at least one nearby vehicle comprises recognizing a vehicle type of the at least one nearby vehicle.

6. The method of claim 5, wherein identifying the vehicle position information further comprises indexing the vehicle type, the lane recognition information, and the vehicle position information as vehicle information of the at least one nearby vehicle.

7. The method of claim 6, wherein calculating the attention degree of the at least one at least one nearby vehicle comprises calculating the speed of the at least one nearby vehicle based on the vehicle speed of the target vehicle, a current relative distance of the at least one nearby vehicle, and a previous relative distance of the at least one nearby vehicle.

8. The method of claim 7, wherein calculating the attention degree of the at least one nearby vehicle comprises
setting a window for the at least one nearby vehicle and checking a center of the window, and
identifying an inter-lane position of the at least one nearby vehicle based on the center of the window.

9. The method of claim 8, wherein calculating the attention degree of the at least one nearby vehicle further comprises
detecting number of lane changes of the at least one nearby vehicle, whether a brake light of the at least one nearby vehicle is turned on, and a frequency of lighting the brake light of the at least one nearby vehicle from the vehicle vicinity image.

10. The method of claim 9, wherein calculating the attention degree of the at least one nearby vehicle comprises
calculating the attention degree of the at least one nearby vehicle based on the speed of the at least one nearby vehicle, the vehicle position information of the at least one nearby vehicle, the relative distance of the at least one nearby vehicle, and the vehicle speed of the target vehicle, when the at least one nearby vehicle is either in front of or behind the target vehicle.

11. The method of claim 10, wherein calculating the attention degree of the at least one nearby vehicle comprises
calculating the attention degree of the at least one nearby vehicle by additionally using the number of lane changes, a speed limit of a road where the target vehicle is driving, the vehicle speed of the target vehicle, and the inter-lane position of the at least one nearby vehicle.

12. The method of claim 9, wherein calculating the attention degree of the at least one nearby vehicle comprises
calculating the attention degree of the at least one nearby vehicle based on number of nearby vehicles positioned in a blind spot, when the at least one nearby vehicle is positioned in a blind spot of the target vehicle.

13. The method of claim 1, wherein displaying the alarm on the screen comprises
outputting an alarm image and sound simultaneously when the attention degree is greater than or equal to a predetermined first threshold, and
outputting the alarm image when the attention degree is greater than a predetermined second threshold or is less than the first threshold.

14. A system for displaying an attention degree of a nearby vehicle, the system comprising:
a sensor that collects a vehicle vicinity image of the target vehicle;
a display that displays an image of the nearby vehicle and an alarm for the nearby vehicle; and
at least one processor,
wherein the at least one processor is configured to identify vehicle recognition information and a relative distance of the nearby vehicle from the vehicle vicinity image, and calculate the attention degree of the nearby vehicle based on a speed of the nearby vehicle calculated from the relative distance and a vehicle speed of the target vehicle, the vehicle speed of the target vehicle, the relative distance, and vehicle position information of the nearby vehicle.

15. The system of claim 14, wherein the at least one processor is configured to map a vehicle and a vehicle type for recognition of the vehicle type of the nearby vehicle through machine training with a training data set.

16. The system of claim 15, wherein the at least one processor is configured to set a window for the nearby vehicle, identify a center of the window, and identify an inter-lane position of the nearby vehicle based on the center of the window.

17. The system of claim 14, wherein the at least one processor is configured to extract number of lane changes of the nearby vehicle, whether a brake light of the nearby vehicle is turned on, and a frequency of lighting the brake light of the nearby vehicle, which are used as parameters for calculating the attention degree of the nearby vehicle.

18. A vehicle comprising the system of claim 14, wherein the vehicle is the target vehicle.
